(19) United States
(12) Patent Application Publication
(10) Pub. No.: US 2025/0218614 A1
(43) Pub. Date: Jul. 3, 2025

(54) Ventilated Storage System and Method Enabling Triangular Storage Array of Casks that Contain Hazardous Radioactive Materials

(71) Applicant: NAC International Inc., Peachtree Corners, GA (US)

(72) Inventors: George CARVER, Peachtree Corners, GA (US); Jay WELLWOOD, Peachtree Corners, GA (US); Michael YAKSH, Lilburn, GA (US)

(21) Appl. No.: 18/429,907

(22) Filed: Feb. 1, 2024

Related U.S. Application Data
(60) Provisional application No. 63/526,787, filed on Jul. 14, 2023.

(51) Int. Cl. G21F 5/10

(52) U.S. Cl. CPC G21C 19/07

(57) ABSTRACT

Embodiments of a ventilated storage system and method are provided for enabling space-efficient storage of casks containing hazardous nuclear materials. Each of a plurality of dry storage casks has a ventilated overpack with air inlets at or near the bottom and air outlets at or near the top so that ambient air flows into the air inlets, through the overpack, and out of the air outlets for venting and cooling the hazardous nuclear material. A storage pad on which the casks sit each have a plurality of air flow channels that provide air to the air inlets situated at the bottoms of the casks. The storage pad enables the casks to be placed closer together in a more space-efficient triangular array.

### CLAIM OF PRIORITY

This application claims priority to and the benefit of application No. 63/526,787, filed Jul. 14, 2023, under attorney docket no. 61404-8200, which is incorporated herein by reference in its entirety.

### FIELD OF THE INVENTION

The embodiments of the present disclosure generally relate to storage of hazardous radioactive materials and, more particularly, to dry storage of casks containing hazardous radioactive material(s), for example but not limited to, spent nuclear fuel.

### BACKGROUND OF THE INVENTION

At commercial nuclear power plants, spent nuclear fuel has been stored in deep reservoirs of water, often called spent fuel pools, within the nuclear power plant. When these spent fuel pools reach their spent fuel capacity limits, or when the nuclear power plant undergoes a complete removal of spent fuel from the spent fuel pool at the end of the life of the facility, the fuel can be transferred into metal canisters having final closure lids that are welded closed or sealed with mechanical apparatus at the power plants following the spent fuel or radioactive waste loading. The sealed canister is then placed into a ventilated storage overpack (typically consisting of layers of steel and concrete) which serves as an enclosure that provides mechanical protection, passive heat removal features, and additional radiation shielding for the inner metal canister that contains the radioactive material.

The ventilated storage overpack, containing the welded or bolted metal canister within which the radioactive materials are stored, is then placed in the designated secure location outside of the nuclear power plant structure typically on owner-controlled property so as to ensure proper controls and monitoring are performed in connection with the ventilated storage overpack containing the metal canister.

U.S. Pat. No. 11,676,736, which is incorporated herein by reference, describes the use of a ventilated metal storage overpack (VMSO) with ventilation inlets on the bottom and ventilation outlets in the lid in order to enable cooling via ambient air passing through the cask via the ventilated overpack. Because there are extremely limited area limitations in many storage facilities, the VMSO was designed to store hazardous radioactive material in less space by using a smaller diameter overpack made of primarily metals as opposed to primarily concrete.

### SUMMARY OF THE INVENTION

Embodiments of a ventilated storage system and method are set forth in the present disclosure that enable implementation of a more space-efficient, or compact, triangular storage array for storing spent nuclear fuel casks.

The embodiments are particularly useful and preferable in connection with using the VMSOs described above, but are not limited to, this type of ventilated overpack or this type of cask. The embodiments of the present disclosure can be used in connection with any cask that uses ambient air for cooling and that has air inlets situated at or near the bottom and air outlets at or near the top.

The triangular storage array reduces the requisite area to store multiple canisters of radioactive waste. By not having lateral inlets and outlets for the convective air flow, the casks can effectively be positioned in very close proximity (within inches) of each other on a storage pad. This design alternative is a complex design of the storage pad that is an integrated part of the storage system and uniquely optimizes storage capacity for extremely limited areal requirements.

Other embodiments, systems, apparatus, methods, features, and advantages of the present invention will be apparent to one with skill in the art upon examination of the following drawings and detailed description. It is intended that all of the foregoing be included within this disclosure, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure.

FIG. 1 is a perspective view of the storage pad of the present disclosure on which casks are placed in a compact triangular storage array, showing entry of ambient air into inlets situated on sides of the storage pad and exiting of the air out of air outlets situated on the tops of the casks that store the hazardous radioactive materials.

FIG. 2 is cross sectional view showing ambient air flow through the pad in air channels and into a cask.

FIG. 3 is a perspective view showing interfacing of vents of the casks and air outlets of the pad.

FIG. 4 is a perspective view showing use of the storage pad with the VMSO described and shown in U.S. Pat. No. 11,676,736 and with the Modular Portable Cask Transfer Facility described and shown in U.S. Pat. No. 10,614,925.

FIG. 5 is a top view of the triangular array.

FIG. 6 is a side view of the triangular array.

### DETAILED DESCRIPTION OF PREFERRED EMBODIMENT(S)

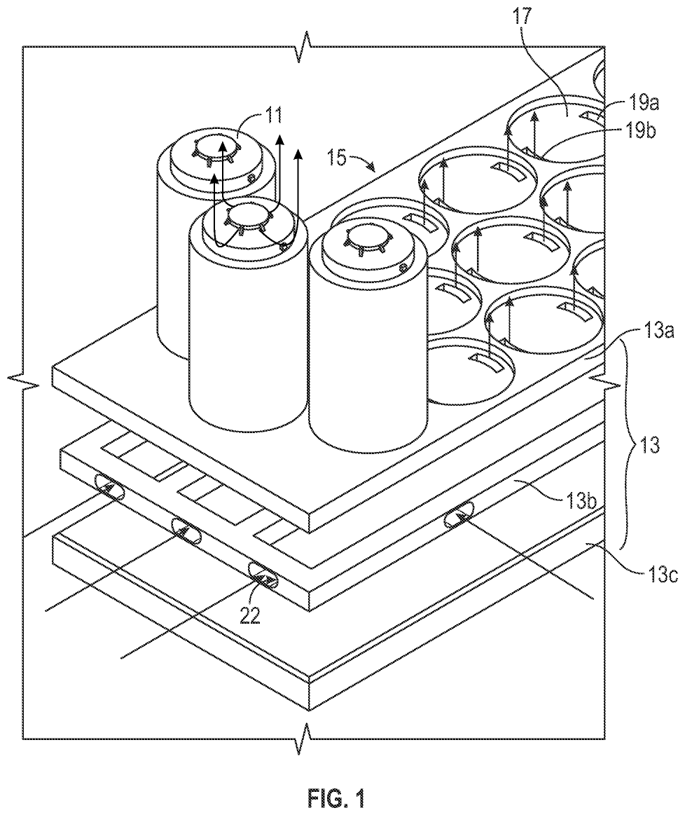

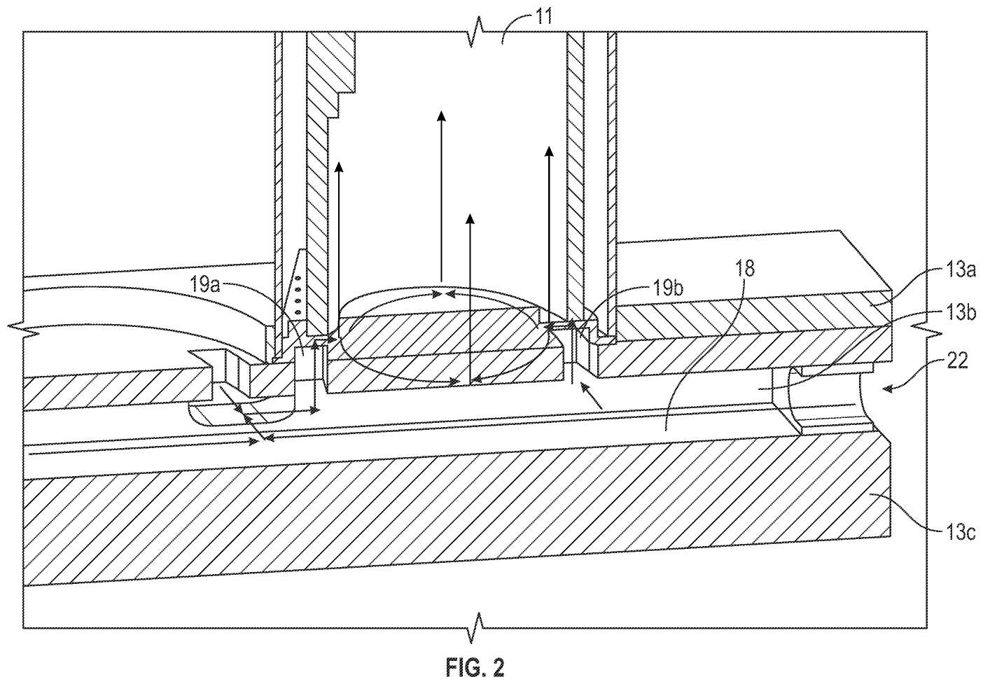

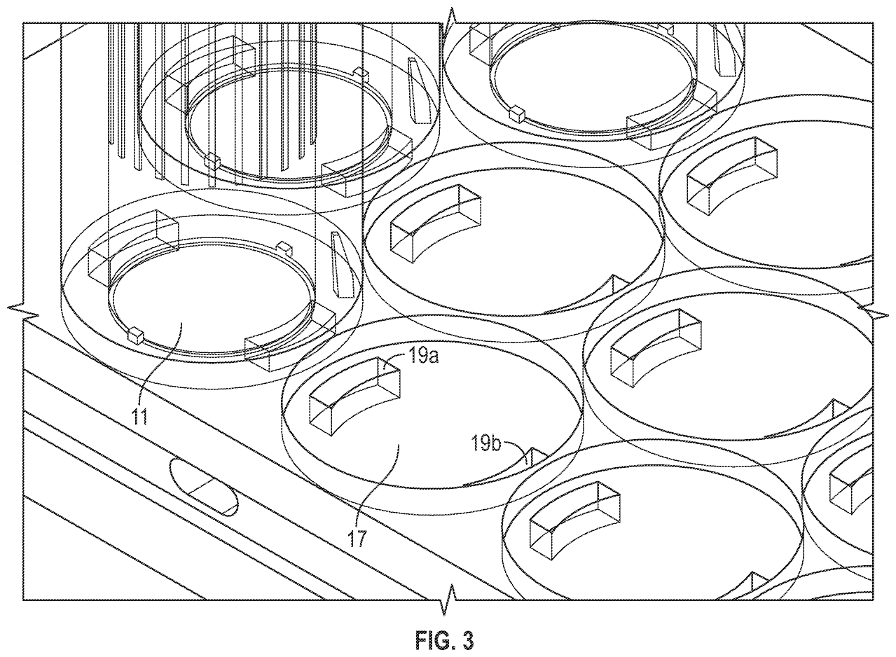

As shown in FIGS. 1 through 3, in order to allow airflow through ventilated metal storage overpacks 11 (VMSOs), a pad 13 upon which the storage casks 11 sit provides an interface for the source of air flow. In this description, “VMSO” is any cask that uses ambient air for cooling and that has air inlets situated at or near the bottom and air outlets at or near the top. Incorporating air inlet paths in and through the storage pad 13 that the VMSOs 11 are installed on, as illustrated by arrows in FIGS. 1 and 2, allows for densifying the storage array 15 to a compact triangular arrangement and also eliminates any radiation streaming associated with the typically exposed air inlets.

In the preferred embodiment, the VMSO 11 is constructed as described in U.S. Pat. No. 11,676,736. In this regard, the VMSO 11 has a side wall with an inner metal layer and one or more sets of alternating layers. Each set includes a neutron absorbing layer adjacent to another metal layer so that neutron-absorbing and metal layers alternate throughout the side wall. The neutron-absorbing layer or layers are designed to absorb neutron particles radiated from the radioactive nuclear waste, and the metal layers are designed to absorb gamma particles radiated from the radioactive materials. Furthermore, for ventilation and cooling, each VMSO 11 has four air inlets at its bottom and four air outlets near its top.

By incorporating linear and cross flow air supply plenums, or channels, a single air chamber is developed in which the bottom of the VMSOs 11 are integrated. The air inlets, located at the bottom of the VMSOs 11, are now connected to the developed air chamber, thereby permitting the VMSOs 11 to be moved substantially closer to one another as shown in the triangular array 15.

In the preferred embodiment, the pad 13 is a multilayered structure, as shown in FIG. 1, with a top layer 13a having a plurality of circular receptacles 17, a middle layer 13b situated under and supporting the top layer 13a and having airflow channels 18 and peripheral air flow inlets 22, and a bottom layer 13c situated under and supporting the middle layer 13b. Preferably, but not limited to, each of the layers 13a, 13b, 13c is rectangular in shape. Each of the receptacles 17 has a bottom support surface and a circular vertical side wall. The receptacles 17 receive and support respective casks 11. The receptables 17 arrange the casks 11 in the compact triangular array 15, and the bottom support surface has the air outlets 19 of the pad. The preferred embodiment shows, but is not limited to, two air outlets 19a, 19b in each receptacle 17, whereas each of the VMSOs 11 show, but is not limited to, four underlying air inlets.

Specific advantages of this unique approach to incorporating air inlet plenums into the storage pad 13 include, but are not limited to, the reduction of areal requirements for the placement of storage casks 11 and simplicity of air inlet inspections, required by regulatory requirements, during storage. Instead of having to inspect four air inlets of each storage cask 11, the inspection only needs to examine the peripheral air inlets 22 at the sides of the storage pad 13. In terms of temperature monitoring devices that are required, the centralized VMSO outlet potentially requires only a single monitoring device, such as that used in a contemporary storage cask 11 deployed in the common singular storage configuration.

An additional distinct advantage of this unique triangular storage array is the inherent improved seismic performance of a spent fuel storage system which is packed tightly and whose integrated performance will can result in greater stability during postulated seismic activity and can potentially reduce the need for seismic restraints typically required for spent fuel storage systems in high-seismic regions of the world.

By utilization of an axial airflow, the VMSOs 11 and the integrated storage pad, the invention primarily optimizes the areal density of a spent fuel storage system and further results in improvements in storage system monitoring, seismic performance, operational performance, and reduces both occupational radiation exposure and offsite radiation exposure.

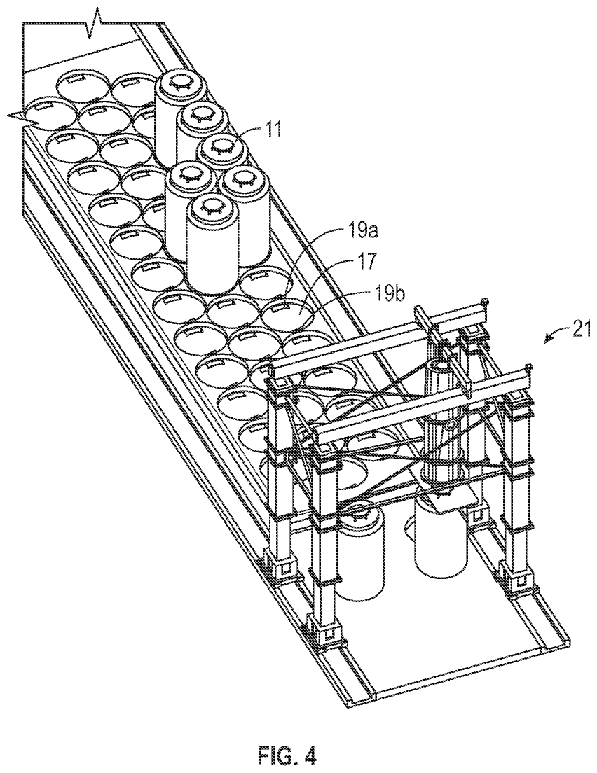

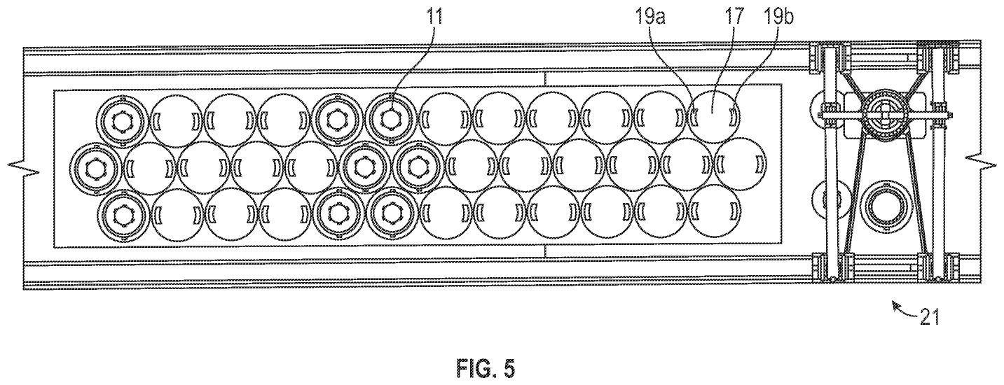

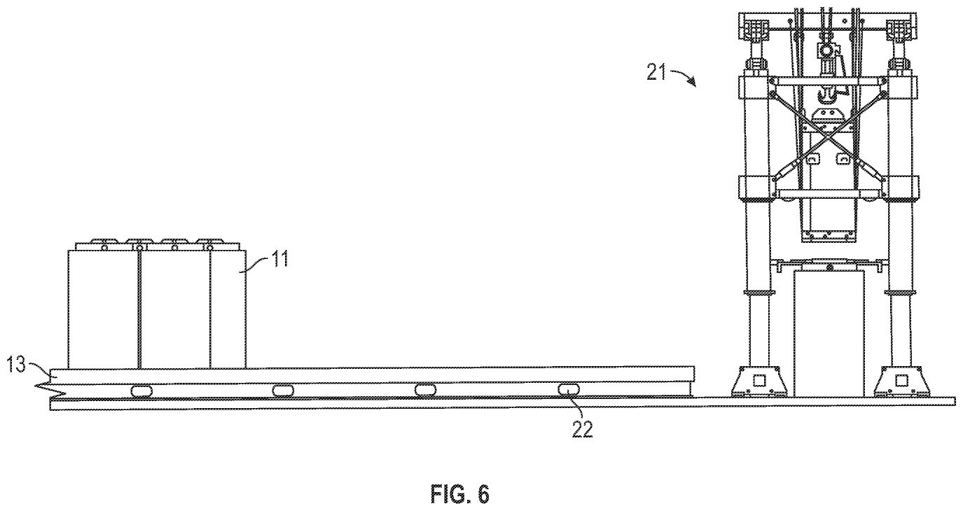

As illustrated in FIGS. 4 through 6, the reduction in storage envelope can also be integrated with a modular portable cask transfer facility 21 described and shown in U.S. Pat. No. 10,614,925, which is incorporated herein by reference. This approach allows for either a canister transfer at the pad 13 or direct loaded VMSO placement.

The triangular array and supporting plenums, or channels, can be configured such that an initial deployment can be installed then can be expanded with additional triangular array(s) in sections as the need for increased storage of nuclear materials is recognized in any number of pluralities, as needed.

Finally, it should be emphasized that the above-described embodiments of the present invention, particularly, any “preferred” embodiments, are merely possible nonlimiting examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention.

As an example of a variation, the air outlets associated with the pad can be designed to deliver air in a horizontal direction to the casks 11 if the casks 11 have air inlets on the side(s).

At least the following is claimed:

1. A ventilated storage system for efficiently storing hazardous nuclear material, the system comprising:
a plurality of dry storage casks having the hazardous nuclear material, each cask having a ventilated overpack with air inlets on the bottom and air outlets on the top so that ambient air flows into the air inlets, through the overpack, and out of the air outlets for cooling the hazardous nuclear material; and
a storage pad on which the casks sit, the pad having a plurality of air flow channels that provide air to the air inlets situated at the bottoms of the casks.

2. The system of claim 1, wherein from a top view vantage point, the casks are arranged in a triangular array.

3. The system of claim 1, wherein the pad comprises:
a top that supports the casks;
a bottom;
a plurality of peripheral sides extending between the top and the bottom; and
wherein the air flow channels have a plurality of air inlets situated in the sides of the pad and wherein the air channels extend horizontally through the pad and vertically through the pad to air outlets under the casks.

4. The system of claim 3, wherein the pad comprises a plurality of circular receptacles having a bottom support surface and a circular vertical side wall, the receptacles receiving and supporting respective casks, the receptables arranging the casks in a triangular array, and the bottom support surface comprising the air outlets of the pad.

5. The system of claim 4, wherein the storage pad comprises three layers including a top layer having the circular receptacles, a middle layer situated under and supporting the top layer and having the airflow channels and the peripheral air flow inlets creating a ventilation air chamber, and a bottom layer situated under and supporting the middle layer.

6. The system of claim 3, wherein the air inlets in the sides of the pad are less in number than the air inlets of the casks.

7. A storage pad on which dry storage casks can reside, the pad having a plurality of air flow channels that provide ambient air to a plurality of air inlets situated at bottoms of the casks.

8. The pad of claim 7, further comprising a plurality of dry storage casks having the hazardous nuclear material and residing on the pad, each cask having a ventilated overpack with air inlets on the bottom and air outlets on the top so that ambient air flows into the air inlets, through the overpack, and out of the air outlets for cooling the hazardous nuclear material.

9. The pad of claim 8, wherein from a top view vantage point, the casks are arranged in a triangular array.

10. The pad of claim 8, wherein the overpacks are made, in substantial part, of a plurality of metals and without concrete.

11. The pad of claim 7, wherein the pad comprises:
a top that can support the casks;
a bottom;
a plurality of peripheral sides extending between the top and the bottom; and
wherein the air flow channels have a plurality of air inlets situated in the sides of the pad and wherein the air channels extend horizontally through the pad and vertically through the pad to air outlets under where the casks would reside.

12. The pad of claim 11, wherein the pad comprises a plurality of circular receptacles having a bottom support surface and a circular vertical side wall, the receptacles for receiving and supporting respective casks, the receptables designed to arrange the casks in a triangular array, and the bottom support surface comprising the air outlets of the pad.

13. The pad of claim 12, wherein the storage pad comprises three layers including a top layer having the circular receptacles, a middle layer situated under and supporting the top layer and having the airflow channels and the peripheral air flow inlets, and a bottom layer situated under and supporting the middle layer.

14. The pad of claim 11, wherein the air inlets in the sides of the pad are substantially less in number than the air inlets of the casks.

15. A ventilated storage system for efficiently storing hazardous nuclear material, the system comprising:
a plurality of dry storage casks having the hazardous nuclear material, each cask having a ventilated overpack with air inlets on the bottom and air outlets on the top so that ambient air flows into the air inlets, through the overpack, and out of the air outlets for cooling the hazardous nuclear material;
a storage pad on which the casks sit, the pad having a plurality of air flow channels that provide air to the air inlets situated at the bottoms of the casks;
wherein from a top view vantage point, the casks are arranged in a triangular array;
wherein the pad comprises:
a top that supports the casks;
a bottom;
a plurality of peripheral sides extending between the top and the bottom; and
wherein the air flow channels have a plurality of air inlets situated in the sides of the pad and wherein the air channels extend horizontally through the pad and vertically through the pad to air outlets under the casks.

16. The system of claim 15, wherein the pad comprises a plurality of circular receptacles having a bottom support surface and a circular vertical side wall, the receptacles receiving and supporting respective casks, the receptables arranging the casks in a triangular array, and the bottom support surface comprising the air outlets of the pad.

17. The system of claim 16, wherein the storage pad comprises three layers including a top layer having the circular receptacles, a middle layer situated under and supporting the top layer and having the airflow channels and the peripheral air flow inlets, and a bottom layer situated under and supporting the middle layer.

18. The system of claim 15, wherein the air inlets in the sides of the pad are less in number than the air inlets of the casks.
